(19) United States
(12) Patent Application Publication
(10) Pub. No.: US 2015/0277853 A1
(43) Pub. Date: Oct. 1, 2015

(54) AUDIO FILE PROCESSING METHOD AND PLAYER USING THE SAME

(71) Applicant: MediaTek Singapore Pte. Ltd., Singapore (SG)

(72) Inventors: Xueping LI, Hefei City (CN); Sheng-Nan WANG, Hefei City (CN)

(21) Appl. No.: 14/674,111

(22) Filed: Mar. 31, 2015

(30) Foreign Application Priority Data
Mar. 31, 2014 (CN) 201410126810.1

(51) Int. Cl. G06F 3/16; G05B 15/02

(52) U.S. Cl. CPC G06F 3/165; G05B 15/02

(57) ABSTRACT

An audio file processing method and player are provided. The audio file processing method includes: reading at least one audio file from a Blu-ray disc via a player, compressing the at least one audio file to generate at least one compressed audio file, and storing the at least one compressed audio file in a system cache of the player. According to the above method, the usage of the system cache is reduced when playing audio files from high definition disc and the cost is reduced accordingly.

### CROSS REFERENCE TO RELATED APPLICATIONS

This application claims priority of China Patent Application No. 201410126810.1, filed on Mar. 31, 2014, the entirety of which is incorporated by reference herein.

### BACKGROUND OF THE INVENTION

1. Field of the Invention

The invention relates to an audio file processing method and player using the same, more particularly, to a Blu-ray Disc Java audio (BDJ audio) file processing method and Blu-ray (BD) player using the same.

2. Description of the Related Art

With the popularity of high-definition discs, players capable of playing high-definition content, such as BD player, have become the mainstream in the market.

Compared with traditional DVD players, the system caches required by the players capable of playing high-definition content have increased significantly and the associated cost increases accordingly as well.

### BRIEF SUMMARY OF THE INVENTION

One technical issue solved by an embodiment of the invention is to reduce the cost of the Blu-ray player by providing an audio file processing method and a player using the same.

In one embodiment of the invention, an audio file processing method is provided to solve the problem in the conventional art. The method comprises the steps of reading at least one audio file from a Blu-ray disc via a player, compressing the at least one audio file to generate at least one compressed audio file, and storing the at least one compressed audio file in a system cache of the player.

In one embodiment, the step of compressing the at least one audio file comprises: compressing at least one data block of the at least one audio file by a compression algorithm.

In one embodiment, the step of compressing at least one data block of the at least one audio file further comprises: compressing the data block to between a quarter and a tenth of its original size using the compression algorithm.

In one embodiment, the compression algorithm is an adaptive differential pulse code modulation, MP3, MP2, A-law, μ-law or an adaptive multi rate coding/decoding.

In one embodiment, the data block is a PCM data block.

In one embodiment, the step of reading the at least one audio file from the Blu-ray disc is implemented by a media middleware, which reads the audio file from the Blu-ray disc via SCC connector.

In one embodiment, the step of compressing the audio file is implemented by a media middleware.

In one embodiment, the step of reading the at least one audio file from the Blu-ray disc or the step of compressing the at least one audio file can be controlled by a time controller or in a thread.

In one embodiment, the method further comprises the steps of: acquiring the at least one compressed audio file from the system cache and decompressing the at least one compressed audio file when there is a request for the audio file to be played; and outputting the audio file and decoding the audio file for playing.

In one embodiment, the step of acquiring the at least one compressed audio file is implemented by a driver of the player.

In one embodiment, the step of decompressing the at least one compressed audio file is implemented by an audio driver or digital signal processor of the player.

In one embodiment, the step of outputting and decoding the audio file is implemented by DAC, HDMI or SPDIF.

In another embodiment, a player is provided to solve the above issues. The player comprises a reading module, a compression module and a writing module. The reading module reads at least one audio file from a Blu-rat disc. The compression module compresses the at least one audio file to generate at least one compressed audio file. The writing module writes or stores the at least one compressed audio file in a system cache of the player.

In one embodiment, the compression module compresses at least one data block of the at least one audio file by a compression algorithm.

In one embodiment, the reading module reads at least one audio file according to a format of a Blu-ray disc.

In one embodiment, the compression algorithm is one of an adaptive differential pulse code modulation, MP3, MP2, A-law, μ-law and an adaptive multirate coding/decoding.

In one embodiment, the player further comprises an access module, a decompressing module and an output module. The access module acquires the at least one compressed audio file from the system cache when the audio file is requested to be played. The decompression module decompresses the at least one compressed audio file to generate at least one decompressed audio file. The output module outputs the at least one decompressed audio file for playing.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a Blu-ray player according to an embodiment of the invention.

FIG. 2 is a flow chart of an audio file processing method according to an embodiment of the invention.

FIG. 3 is a flow chart of an audio file processing method according to another embodiment of the invention.

FIG. 4 is a functional block diagram of a player according to an embodiment of the invention.

FIG. 5 is a schematic showing signal flow direction among each functional block of the player according to one embodiment of the invention.

FIG. 6 shows the spectrum characteristics of the uncompressed audio data.

FIG. 7 shows the spectrum characteristics of the compressed audio data using the ADPCM algorithm.

FIG. 8 shows the spectrum characteristics of the compressed audio data using the MP3 algorithm.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

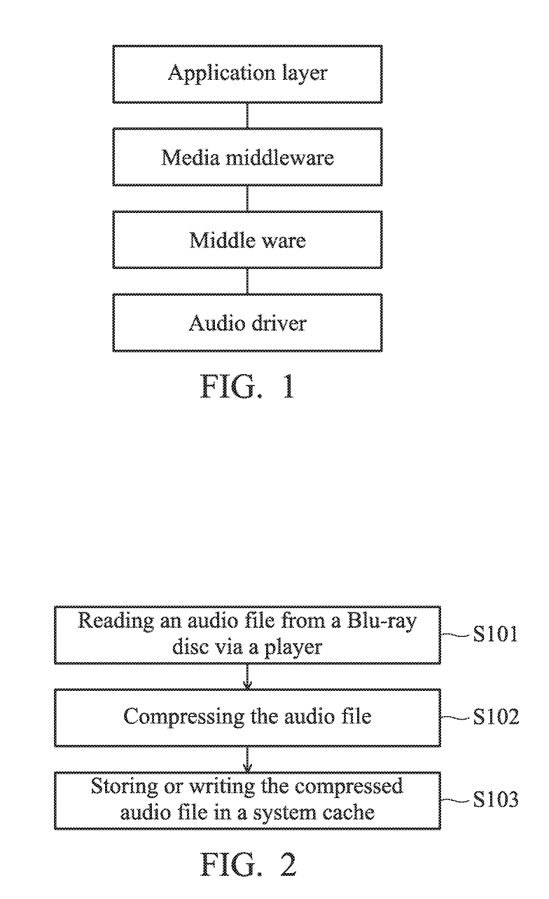

FIG. 1 is a schematic diagram of a Blu-ray player according to an embodiment of the invention. The Blu-ray player comprises a software layer and a hardware layer, wherein the software layer comprises an application layer, a media middleware, and a middle ware. The hardware layer comprises an audio driver, and a digital signal processor. The audio files processed by the audio processing method described in embodiments of the invention relate to BDJ audio, and especially to IA/Interactive audio. The invention is not limited to the embodiments described in the following paragraphs. A person skilled in the art can use the technical feature of the invention to process other types of audio files to reduce the system cache and save cost.

FIG. 2 is a flow chart of an audio processing method according to an embodiment of the invention. The audio processing method is performed in a player, such as the Blu-ray player. The audio processing method comprises the steps of:

S101: reading at least one audio file from a Blu-ray disc.

The Blu-ray player reads at least one audio file from the Blu-ray disc, wherein the Blu-ray disc can provide Java procedure, customized UI (user interface) and various audio/video contents. The audio file is for example a Blu-ray disc java audio file, and the at least one audio file is read following a format of the Blu-ray disc.

The step of reading the audio file from the Blu-ray disc is implemented by the Blu-ray player, especially by the media middleware of the Blu-ray player, and the step can be controlled by a time controller or in a thread.

S102: compressing the at least one audio file.

The at least one audio file read from the Blu-ray disc is then compressed in terms of data block according to a compression algorithm in this step. The data block is for example a PCM (Pulse Code Modulation) data block. When the player compresses the audio file(s), incoming frames are compressed according to a fixed PCN and the compressed data is output in the form of a code stream. Since the size requirements of the incoming frames are different for different players, the size can range from hundreds of words to thousands of words. When the audio file does not satisfy the requirement of the incoming frame, the audio file can be divided into multiple data blocks and each data block is compressed as a PCM frame being compressed. The size of a data block varies according to the compression method or compression algorithm. Therefore, in practice, the size of the data block is determined according to the compression method or compression algorithm being used.

In one embodiment, after the compressing step, the size of at least one data block of the at least one audio file could be compressed to about a quarter to a tenth of original size. For example, assuming the size of the original audio file is 300 Mb, the size of the compressed audio file may be 30 Mb, 45 Mb or 50 Mb.

In one embodiment, the step of compressing the audio file is implemented by the media middleware of the Blu-ray player. During compression, up to eight audio files can be processed simultaneously, wherein each audio file contains one or a plurality of data blocks (PCM blocks) and the compressing step is applied to each data block to generate a compressed data block. In one embodiment, the step of compressing the audio file can also be controlled by a time controller or in a thread.

According to the present invention, the compression algorithm could be, but not limited to one of a group comprising adaptive differential pulse code modulation (ADPCM), MP3, MP2, A-law, μ-law or an adaptive multi rate (AMR) codec.

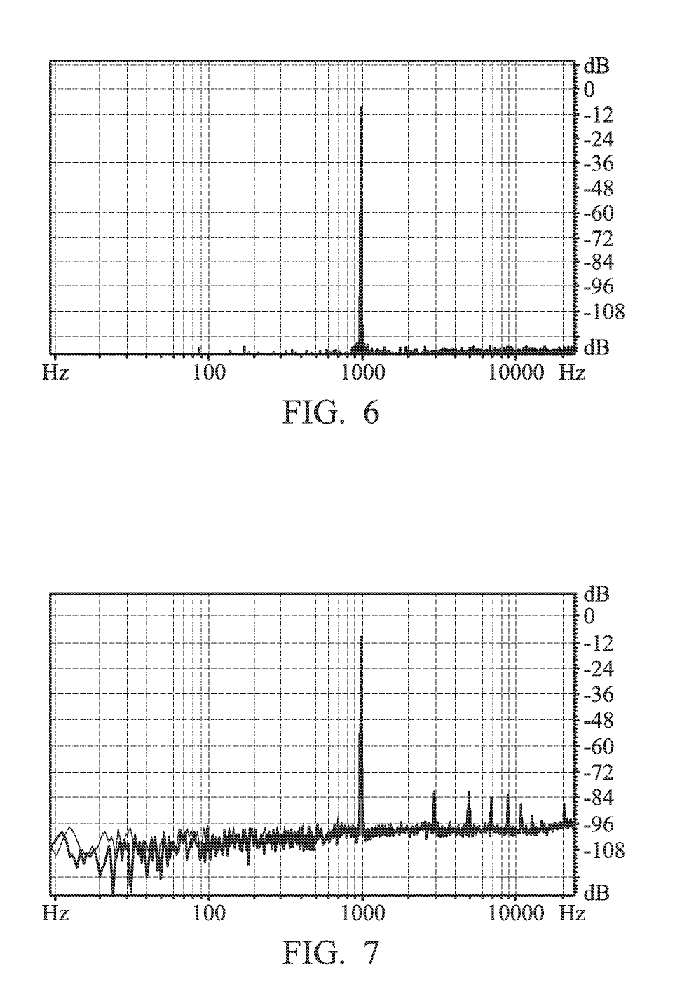

For the ADPCM compression algorithm, correlations between samples of the audio signal are utilized to compress audio signals. In addition, self-adaptive prediction method and self-adaptive quantization method are also utilized by at least one predictor and at least one quantizer respectively in view of non-stationary characteristic of the audio signal. In other words, parameters of the predictor and quantizer could be vary with statistical characteristics of input audio signal adaptively to reach the optimum value, so that the voice quality of compressed audio signals is similar to the voice quality of audio signal transmitted via the network, wherein the bitrate of the audio signals is 32 Kbps and the sample rate is 8 k Hz. Using the ADPCM algorithm to compress the audio file, the impact on audio quality is very small and the system cache can be saved. For example, FIG. 6 shows the spectrum characteristics of the uncompressed audio data and FIG. 7 shows the spectrum characteristics of the compressed audio data using the ADPCM algorithm. According to FIG. 7, the compressed audio data generates −96 db noise, but the noise scarcely affects audio quality at all because it almost cannot be detected by the human ear.

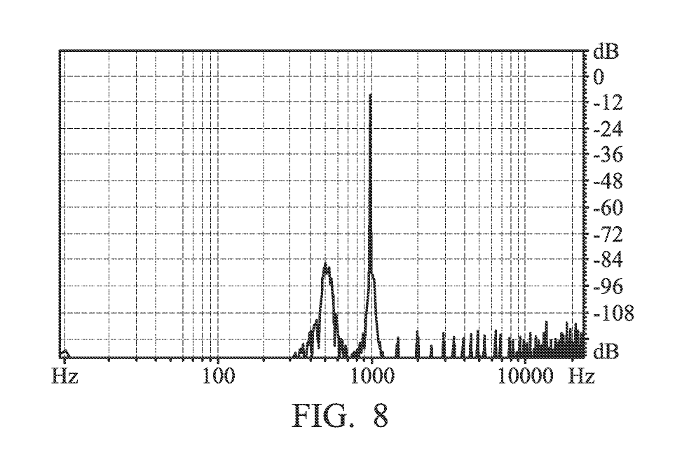

For the MP3 and MP2 compression algorithms, both of the MP3 and MP2 compression algorithms are belong to lossy compression algorithms but have greater compression ratios. Specifically, the compression ratio of MP2 ranges from 6:1 to 8:1 and the compression ratio of MP3 ranges from 10:1 to 12:1. It is to say, the storage space for one minute of music in CD format can be reduced from 10 MB to only 1 MB without distortion after MP3 compression algorithm. Please refer to FIG. 8 and FIG. 6. FIG. 8 shows the spectrum characteristics of the compressed audio data using the MP3 compression algorithm. According to FIG. 6 and FIG. 8, the compressed audio data generates −84 db noise that occurs between 300 Hz to 700 Hz and greater than 1.5 KHz, but the noise scarcely affects audio quality at all because it almost cannot be detected by the human ear.

For nonlinear quantization, there are two relationships defined between the sampled input signal amplitude and quantized output data: one is called μ-Law companding algorithm (i.e. μ-Law) and another is called A-Law companding algorithm (i.e. A-Law). The characteristic of the A-law displays that the above relationship is linearity of small signals but exponential of larger signals. The above two companding algorithms usually combine compression, quantization and encoding in one process. Generally, the A-law can be formed by 13 approximate straight line segments (A=87.6) and the μ-Law can be formed by 15 approximate straight line segments, so as to implemented in digital circuit.

As for the AMP compression algorithm, it is an encoding/decoding method available for a greater data transmission rate. Specifically, a lower encoding rate of the audio signal and a better error correction capability can be achieved by using the AMR compression algorithm even the existing of audio interference signal. Moreover, the AMP algorithm can be also applied in coding/decoding standards of cellular system.

In practice, the compression algorithm can be selected from the above described compression algorithms on the basis of the practical computing ability of a processor of the player, wherein the impact on the processor of ADPCM compression algorithm is less than other compression algorithms.

Furthermore, the actual adopted compression algorithm for the invention is not limited to the above examples. A person skilled in the art can use other compression algorithms for compressing the audio file according to teaching of the invention. Further description directed to the other compression algorithms is omitted in the following paragraphs for brevity.

Step S103: storing or writing the at least one compressed audio file in a system cache of the player.

The compressed audio file is then stored in the system cache. In another embodiment, the compressed audio file is stored in a temporary buffer of the system cache.

By adopting the audio file processing method, the usage of the system cache can be significantly reduced. Take the ADPCM compression algorithm for example, almost three-quarters of the memory space of the system cache can be saved and the loss of the audio file is small. Assuming that the size of the system cache is 6.5 Mb, 4.875 Mb is saved accordingly. If the MP3 compression algorithm is adopted, nine-tenths of the memory space of the system cache is saved. Assuming the size of the system cache is 6.5 Mb, 5.85 Mb is saved accordingly.

According to the explanation above, the features of the embodiment comprise the steps of reading at least one audio file from a high-definition disc, compressing the at least one audio file to generate at least one compressed audio file, and storing the at least one compressed audio file in a system cache of the player. According to the method, the Blu-ray player only need acquire and decompress the compressed auto files from the system cache and the audio files of the high-definition disc can be played by the Blu-ray player. The usage or the memory size of system cache can be significantly reduced due to the compressed audio files, and the cost of the system cache can be reduced accordingly.

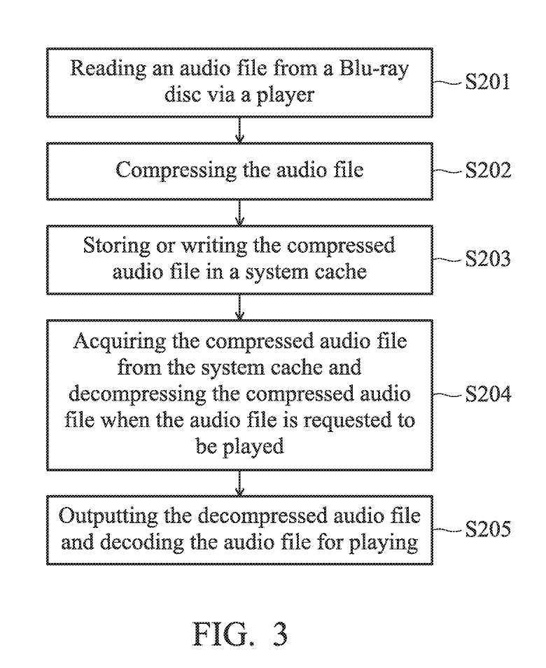

Please refer to FIG. 3. FIG. 3 is a flow chart of an audio file processing method according to another embodiment of the invention. The audio processing method is also performed in the Blu-ray player. The audio processing method comprises the steps of:

S201: reading at least one audio file from a Blu-ray disc via a Blu-ray player.

The Blu-ray player reads at least one audio file from the Blu-ray disc, wherein the Blu-ray disc is capable of storing high quality of audio/video content and high capacity data. The Blu-ray disc can provide Java procedure, customized UI (user interface) and various audio/video contents. The audio file is for example a Blu-ray disc java audio file, and the at least one audio file is read following a format of the Blu-ray disc.

The step of reading the audio file from the Blu-ray disc is implemented by the Blu-ray player, especially by the media middleware of the Blu-ray player, and the step can be controlled by a time controller or in a thread.

S202: compressing the at least one audio file.

The at least one audio file read from the Blu-ray disc is then compressed in terms of data block according to a compression algorithm in this step. The data block is for example a PCM (Pulse Code Modulation) data block. When the player compresses the audio file(s), incoming frames are compressed according to a fixed PCN and the compressed data is output in the form of a code stream. Since the size requirements of the incoming frames are different for different players, the size can range from hundreds of words to thousands of words. When the audio file does not satisfy the requirement of the incoming frame, the audio file can be divided into multiple data blocks and each data block is compressed as a PCM frame being compressed. The size of a data block varies according to the compression method or compression algorithm. Therefore, in practice, the size of the data block is determined according to the compression method or compression algorithm being used.

In one embodiment, after the compressing step, the size of at least one data block of the at least one audio file could be compressed to about a quarter to a tenth of original size. For example, assuming the size of the original audio file is 300 Mb, the size of the compressed audio file may be 30 Mb, 45 Mb or 50 Mb.

In one embodiment, the step of compressing the audio file is implemented by the media middleware of the Blu-ray player. During compression, up to eight audio files can be processed simultaneously, wherein each audio file contains one or a plurality of data blocks (PCM blocks) and the compressing step is applied to each data block to generate a compressed data block. In one embodiment, the step of compressing the audio file can also be controlled by a time controller or in a thread.

According to the present invention, the compression algorithm could be, but not limited to one of a group comprising adaptive differential pulse code modulation (ADPCM), MP3, MP2, A-law, μ-law or an adaptive multi rate (AMR) codec.

For the ADPCM compression algorithm, correlations between samples of the audio signal are utilized to compress audio signals. In addition, self-adaptive prediction method and self-adaptive quantization method are also utilized by at least one predictor and at least one quantizer respectively in view of non-stationary characteristic of the audio signal. In other words, parameters of the predictor and quantizer could be vary with statistical characteristics of input audio signal adaptively to reach the optimum value, so that the voice quality of compressed audio signals is similar to the voice quality of audio signal transmitted via the network, wherein the bitrate of the audio signals is 32 Kbps and the sample rate is 8 k Hz. Using the ADPCM algorithm to compress the audio file, the impact on audio quality is very small and the system cache can be saved. For example, FIG. 6 shows the spectrum characteristics of the uncompressed audio data and FIG. 7 shows the spectrum characteristics of the compressed audio data using the ADPCM algorithm. According to FIG. 7, the compressed audio data generates −96 db noise, but the noise scarcely affects audio quality at all because it almost cannot be detected by the human ear.

For the MP3 and MP2 compression algorithms, both of the MP3 and MP2 compression algorithms are belong to lossy compression algorithms but have greater compression ratios. Specifically, the compression ratio of MP2 ranges from 6:1 to 8:1 and the compression ratio of MP3 ranges from 10:1 to 12:1. It is to say, the storage space for one minute of music in CD format can be reduced from 10 MB to only 1 MB without distortion after MP3 compression algorithm. Please refer to FIG. 8 and FIG. 6. FIG. 8 shows the spectrum characteristics of the compressed audio data using the MP3 compression algorithm. According to FIG. 6 and FIG. 8, the compressed audio data generates −84 db noise that occurs between 300 Hz to 700 Hz and greater than 1.5 KHz, but the noise scarcely affects audio quality at all because it almost cannot be detected by the human ear.

For nonlinear quantization, there are two relationships defined between the sampled input signal amplitude and quantized output data: one is called μ-Law companding algorithm (i.e. μ-Law) and another is called A-Law companding algorithm (i.e. A-Law). The characteristic of the A-law displays that the above relationship is linearity of small signals but exponential of larger signals. The above two companding algorithms usually combine compression, quantization and encoding in one process. Generally, the A-law can be formed by 13 approximate straight line segments (A=87.6) and the μ-Law can be formed by 15 approximate straight line segments, so as to implemented in digital circuit.

As for the AMP compression algorithm, it is an encoding/decoding method available for a greater data transmission rate. Specifically, a lower encoding rate of the audio signal and a better error correction capability can be achieved by using the AMR compression algorithm even the existing of audio interference signal. Moreover, the AMP algorithm can be also applied in coding/decoding standards of cellular system.

In practice, the compression algorithm can be selected from the above described compression algorithms on the basis of the practical computing ability of a processor of the player, wherein the impact on the processor of ADPCM compression algorithm is less than other compression algorithms.

Furthermore, the actual adopted compression algorithm for the invention is not limited to the above examples. A person skilled in the art can use other compression algorithms for compressing the audio file according to teaching of the invention. Further description directed to the other compression algorithms is omitted in the following paragraphs for brevity.

Step S203: storing or writing the at least one compressed audio file in a system cache of the player.

The compressed audio file is then stored in the system cache. In another embodiment, the compressed audio file is stored in a temporary buffer of the system cache.

By adopting the audio file processing method, the usage of the system cache can be significantly reduced. Take the ADPCM compression algorithm for example, almost three-quarters of the memory space of the system cache can be saved and the loss of the audio file is small. Assuming that the size of the system cache is 6.5 Mb, 4.875 Mb is saved accordingly. If the MP3 compression algorithm is adopted, nine-tenths of the memory space of the system cache is saved. Assuming the size of the system cache is 6.5 Mb, 5.85 Mb is saved accordingly. Although the described compression algorithms are lossy compression algorithms, the quality of the audio is not affected and the compression is stable and reliable.

Step S204: acquiring the at least one compressed audio file from the system cache and decompressing the at least one compressed audio file when the audio file is requested to be played.

When the audio file is requested to be played, the compressed audio file is retrieved from the system cache and decompressed according to a corresponding decompression algorithm to generate at least one decompressed audio file.

In one embodiment, the step of acquiring the compressed audio file from the system cache is implemented by the audio driver of the Blu-ray player and the step of decompressing the compressed audio file is implemented by the audio driver or digital signal processor of the player.

Furthermore, if the audio file is compressed according to the ADPCM compression algorithm in the compressing step, a corresponding decompression algorithm of ADPCM decompression algorithm would be adopted to decompress the compressed audio file. If the audio file is compressed according to the MP3 or AMR compression algorithm in the compressing step, a corresponding decompression algorithm of MP3 or AMR decompression algorithm would be adopted to decompress the compressed audio file.

Step S205: outputting the at least one decompressed audio file for playing.

The decompressed audio files are output for playing. The step of outputting the decompressed audio files is implemented in a Digital to Analog Converter (DAC), a High Definition Multimedia Interface (HDMI) or a Sony/Philips Digital Interconnect Format (SPDIF).

According to the above explanation, the features of embodiment comprise steps of reading at least one audio file from a high-definition disc, compressing the at least one audio file to generate at least one compressed audio file, storing the at least one compressed audio file in a system cache, decompressing the at least one compressed audio file, and outputting the at least one decompressed audio file for playing. According to the mechanism, the Blu-ray player only need acquire and decompress the compressed auto files from the system cache then the audio files of the high-definition disc can be played by the Blu-ray player. The usage or the memory size of system cache can be significantly reduced due to the compressed audio files, and the cost of the system cache can be reduced accordingly.

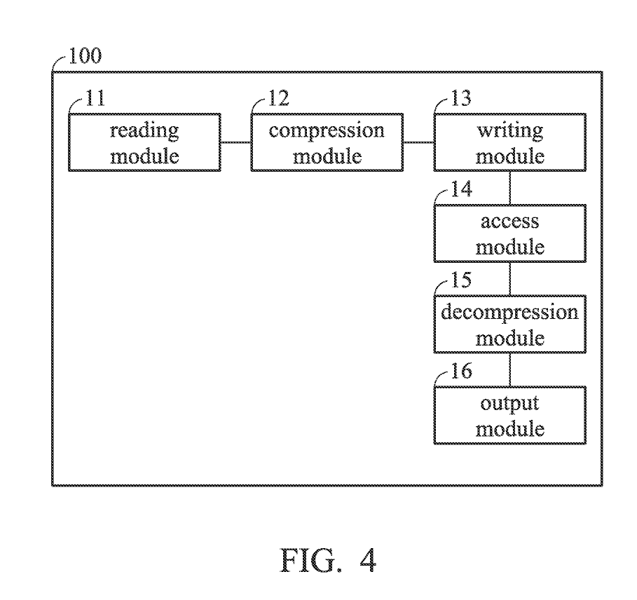

FIG. 4 is a functional block diagram of a player 100 according to an embodiment of the invention. The player is for example the Blu-ray player. The player 100 comprises a reading module 11, a compression module 12 and a writing module 13.

The reading module 11 is arranged for reading at least one audio file from a Blu-ray disc. The player 100 reads the at least one audio file from the Blu-ray disc via the reading module 11, wherein the Blu-ray disc could provide Java procedure, customized UI (user interface) and various audio/video contents.

In one embodiment, the audio file is for example a Blu-ray disc java audio file, and the at least one audio file is read following a format of the Blu-ray disc.

In another embodiment, the reading module 11 reads the at least one audio file of the Blu-ray disc by a BDJ module in the media middleware.

The compression module 12 is arranged for compressing the at least one audio file to generate at least one compressed audio file. Specifically, the at least one audio file is compressed in terms of data block according to a compression algorithm. The data block is for example a PCM data block. When the player compresses the audio file(s), incoming frames are compressed according to a fixed PCN and the compressed data is output in the form of a code stream. Since the size requirements of the incoming frames are different for different players, the size can range from hundreds of words to thousands of words. When the audio file does not satisfy the requirement of the incoming frame, the audio file can be divided into multiple data blocks and each data block is compressed as a PCM frame being compressed. The size of a data block varies according to the compression method or compression algorithm. Therefore, in practice, the size of the data block is determined according to the compression method or compression algorithm being used.

In one embodiment, after the compressing step, the size of at least one data block of the at least one audio file could be compressed to about a quarter to a tenth of original size. For example, assuming the size of the original audio file is 300 Mb, the size of the compressed audio file may be 30 Mb, 45 Mb or 50 Mb.

In one embodiment, the step of compressing the audio file is implemented by the media middleware of the Blu-ray player. During compression, up to eight audio files can be processed simultaneously, wherein each audio file contains one or a plurality of data blocks (PCM blocks) and the compressing step is applied to each data block to generate a compressed data block. In one embodiment, the step of compressing the audio file can also be controlled by a time controller or in a thread.

According to the present invention, the compression algorithm could be, but not limited to one of a group comprising adaptive differential pulse code modulation (ADPCM), MP3, MP2, A-law, μ-law or an adaptive multi rate (AMR) codec.

For the ADPCM compression algorithm, correlations between samples of the audio signal are utilized to compress audio signals. In addition, self-adaptive prediction method and self-adaptive quantization method are also utilized by at least one predictor and at least one quantizer respectively in view of non-stationary characteristic of the audio signal. In other words, parameters of the predictor and quantizer could be vary with statistical characteristics of input audio signal adaptively to reach the optimum value, so that the voice quality of compressed audio signals is similar to the voice quality of audio signal transmitted via the network, wherein the bitrate of the audio signals is 32 Kbps and the sample rate is 8 k Hz. Using the ADPCM algorithm to compress the audio file, the impact on audio quality is very small and the system cache can be saved. For example, FIG. 6 shows the spectrum characteristics of the uncompressed audio data and FIG. 7 shows the spectrum characteristics of the compressed audio data using the ADPCM algorithm. According to FIG. 7, the compressed audio data generates −96 db noise, but the noise scarcely affects audio quality at all because it almost cannot be detected by the human ear.

For the MP3 and MP2 compression algorithms, both of the MP3 and MP2 compression algorithms are belong to lossy compression algorithms but have greater compression ratios. Specifically, the compression ratio of MP2 ranges from 6:1 to 8:1 and the compression ratio of MP3 ranges from 10:1 to 12:1. It is to say, the storage space for one minute of music in CD format can be reduced from 10 MB to only 1 MB without distortion after MP3 compression algorithm. Please refer to FIG. 8 and FIG. 6. FIG. 8 shows the spectrum characteristics of the compressed audio data using the MP3 compression algorithm. According to FIG. 6 and FIG. 8, the compressed audio data generates −84 db noise that occurs between 300 Hz to 700 Hz and greater than 1.5 KHz, but the noise scarcely affects audio quality at all because it almost cannot be detected by the human ear.

For nonlinear quantization, there are two relationships defined between the sampled input signal amplitude and quantized output data: one is called μ-Law companding algorithm (i.e. μ-Law) and another is called A-Law companding algorithm (i.e. A-Law). The characteristic of the A-law displays that the above relationship is linearity of small signals but exponential of larger signals. The above two companding algorithms usually combine compression, quantization and encoding in one process. Generally, the A-law can be formed by 13 approximate straight line segments (A=87.6) and the μ-Law can be formed by 15 approximate straight line segments, so as to implemented in digital circuit.

As for the AMP compression algorithm, it is an encoding/decoding method available for a greater data transmission rate. Specifically, a lower encoding rate of the audio signal and a better error correction capability can be achieved by using the AMR compression algorithm even the existing of audio interference signal. Moreover, the AMP algorithm can be also applied in coding/decoding standards of cellular system.

In practice, the compression algorithm can be selected from the above described compression algorithms on the basis of the practical computing ability of a processor of the player, wherein the impact on the processor of ADPCM compression algorithm is less than other compression algorithms.

Furthermore, the actual adopted compression algorithm for the invention is not limited to the above examples. A person skilled in the art can use other compression algorithms for compressing the audio file according to teaching of the invention. Further description directed to the other compression algorithms is omitted in the following paragraphs for brevity.

The writing module 13 is arranged for writing or storing the at least one compressed audio file in a system cache. Specially, the writing module 13 is arranged for writing or storing the at least one compressed audio file in a system cache or in a temporary buffer of the system cache.

By adopting the audio file processing method, the usage of the system cache can be significantly reduced. Take the ADPCM compression algorithm for example, almost three-quarters of the memory space of the system cache can be saved and the loss of the audio file is small. Assuming that the size of the system cache is 6.5 Mb, 4.875 Mb is saved accordingly. If the MP3 compression algorithm is adopted, nine-tenths of the memory space of the system cache is saved. Assuming the size of the system cache is 6.5 Mb, 5.85 Mb is saved accordingly. Although the described compression algorithms are lossy compression algorithms, the quality of the audio is not affected and the compression is stable and reliable.

Please further refer to FIG. 4, in another embodiment of the invention, the player 100 further comprises an access module 14, a decompression module 15 and an output module 16.

The access module 14 is arranged for acquiring the at least one compressed audio file from the system cache when the audio file is requested to be played. Specifically, the access module 14 is arranged for implementing the step of acquiring the at least on compressed audio file from the system cache by an audio driver of the player.

The decompression module 15 is arranged for decompressing the at least one compressed audio file to generate at least one decompressed audio file. Specifically, the decompression module 15 is arranged for implementing the step of decompressing the compressed audio file by an audio driver or a digital signal processor of the player.

The output module 16 is arranged for outputting the at least one decompressed audio file for playing.

If the audio file is compressed according to the ADPCM compression algorithm in the compress module 12, a corresponding decompression algorithm of ADPCM decompression algorithm would be adopted to decompress the compressed audio file. If the audio file is compressed according to the MP3 or AMR compression algorithm in the compress module 12, a corresponding decompression algorithm of MP3 or AMR decompression algorithm would be adopted to decompress the compressed audio file.

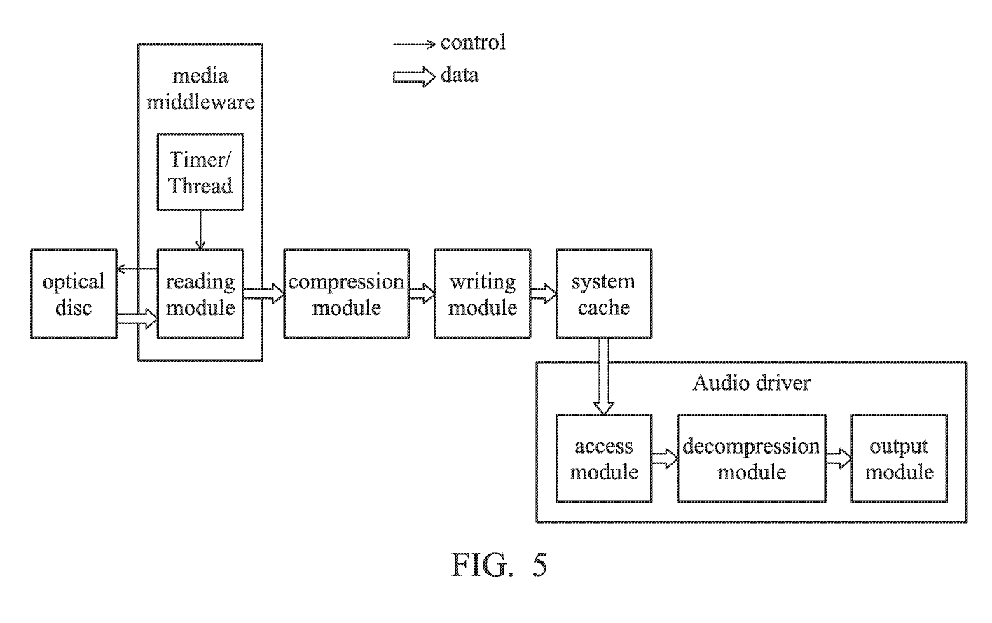

FIG. 5 is a schematic showing signal flow direction among each functional block of the player according to one embodiment of the invention. The access module implements the step of reading data from the Blu-ray disc by the media middleware. The process is controlled by a timer or in a thread. The compression module reads the audio file by the access module via a connector provided by the media middleware and compresses the audio file to generate compressed audio file. Then the compression module stores the compressed data in a system cache by a writing module. When the audio file is requested to be played, the access module acquires the compressed audio file from the system cache, then the decompression module decompresses the compressed audio file to generate decompressed audio file and then the output module outputs the audio file for playing.

The audio file process method and player provided by embodiments of the invention contain the features of steps of reading at least one audio file from a high-definition disc, compressing the at least one audio file to generate at least one compressed audio file, storing the at least one compressed audio file in a system cache, decompressing the at least one compressed audio file, and outputting the at least one decompressed audio file for playing. According to the mechanism, the player only need acquire and decompress the compressed auto files from the system cache then the audio files of the high-definition disc can be played by the player. The usage or the memory size of system cache can be significantly reduced due to the compressed audio files, and the cost of the system cache can be reduced accordingly.

According to the above embodiments, it is understood that the disclosed system, method or device can be implemented by other ways. The disclosed embodiments of devices are examples for illustration. The wording “modules” and “units” are distinguished only for the description according to logic functions. The device can be implemented by other ways. The units or modules can be integrated in one system, or some feature or function is omitted according to the requirement. In another aspect of view, the coupling shown in Figures or discussed in descriptions is directly coupled between two devices, units or circuits, or is communicated connected, or connected via connectors, or indirectly coupled between devices or units. The coupling may refer to mechanically connection or electrically connection.

The individual modules or units described above are only illustrated. In practice, these modules or units may be integrated in one system or device. In another embodiment, these modules or units may be embedded in a different network device and can be selected to implement the invention according to actual requirements.

Furthermore, the functional block described in embodiments of the invention can be integrated in one processing module or implemented in individual modules, or two or more than two functional blocks are integrated in one processing module. The module may be implemented by hardware or software.

If the integrated unit is implemented by software functional units and is individually sold or used, the unit can be stored in a computer readable medium. Based on this understanding, parts or all of the technical features of the invention or the contribution parts of the embodiments, or the technical solutions can be implemented by software. The computing software can be stored in a storage medium and includes instructions to make a computing device, such as a personal computer, a server or network equipment, or a processor to execute the methods described above. The storage medium may be a USB disc, a mobile hard disc, a Read-Only Memory (ROM), a Random Access Memory (RAM), a disc, an optical disc or any other storage medium.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An audio file processing method, comprising:
reading at least one audio file from a Blu-ray disc via a player;
compressing the at least one audio file to generate at least one compressed audio file; and
storing the at least one compressed audio file in a system cache of the player.

2. The method as claimed in claim 1, wherein the step of compressing the at least one audio file further comprises:
compressing at least one data block of the at least one audio file by a compression algorithm.

3. The method as claimed in claim 2, wherein the step of compressing the at least one data block of the at least one audio file further comprises:
compressing the at least one data block to between a quarter to a tenth of an original size thereof by a compression algorithm.

4. The method as claimed in claim 3, wherein the compression algorithm is one of an adaptive differential pulse code modulation, MP3, MP2, A-law, μ-law and an adaptive multi rate coding/decoding.

5. The method as claimed in claim 2, wherein the data block is a PCM data block.

6. The method as claimed in claim 1, wherein the step of reading the at least one audio file from the Blu-ray disc is implemented by a media middleware of the player, which reads the at least one audio file from the Blu-ray disc via SCC connector.

7. The method as claimed in claim 1, wherein the step of compressing the at least one audio file is implemented by a media middleware of the player.

8. The method as claimed in claim 1, wherein the step of reading the at least one audio file from the Blu-ray disc or the step of compressing the at least one audio file can be controlled by a time controller or in a thread.

9. The method as claimed in claim 1, further comprising:
acquiring the at least one compressed audio file from the system cache and decompressing the at least one compressed audio file to generate at least one decompressed audio file; and
outputting the at least one decompressed audio file for playing.

10. The method as claimed in claim 9, wherein the step of acquiring the at least one compressed audio file is implemented by a driver of the player.

11. The method as claimed in claim 9, wherein the step of decompressing the at least one compressed audio file is implemented by an audio driver or a digital signal processor of the player.

12. The method as claimed in claim 9, wherein the step of outputting the at least one decompressed audio file is implemented by a DAC, a HDMI or a SPDIF.

13. A player comprising a reading module, a compression module and a writing module, wherein
the reading module, arranged for reading at least one audio file from a Blu-ray disc;
the compression module, arranged for compressing the at least one audio file to generate at least one compressed audio file; and
the writing module, arranged for writing the at least one compressed audio file in a system cache of the player.

14. The player as claimed in claim 13, wherein the compression module is arranged for compressing at least one data block of the at least one audio file by a compression algorithm.

15. The player as claimed in claim 14, wherein the compressing module is arranged for compressing the at least one data block to between a quarter to a tenth of an original size thereof by a compressing algorithm.

16. The player as claimed in claim 15, wherein the compression algorithm is one of an adaptive differential pulse code modulation, MP3, MP2, A-law, μ-law and an adaptive multi rate coding/decoding.

17. The player as claimed in claim 13, further comprising:
an access module, arranged to acquiring the at least one compressed audio file from the system cache when the audio file is requested to be played;
a decompression module, arranged to decompressing the at least one compressed audio file to generate at least one decompressed audio file; and
an output module, arranged to outputting the at least one decompressed audio file for playing.
